(19) United States
(12) Patent Application Publication
(10) Pub. No.: US 2010/0170369 A1
(43) Pub. Date: Jul. 8, 2010

(54) TORQUE TOOL DEVICE

(75) Inventors: Tetsuya Yokoyama, Tokyo (JP); Sinji Murayama, Tokyo (JP); Satoshi Takaku, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: TOHNICHI MFG. CO., LTD, Ota-ku, Tokyo (JP)

(21) Appl. No.: 12/452,073

(22) PCT Filed: Jun. 5, 2008
(86) PCT No.: PCT/JP2008/060350

§ 371 Date: Feb. 23, 2010

(30) Foreign Application Priority Data
Jun. 18, 2007 (JP) 2007-160167

(51) Int. Cl. B25B 23/14

(52) U.S. Cl. 81/467

(57) ABSTRACT

An object is to provide a torque tool device which can positively identify which torque tool was used to tighten a bolt. Another object is to provide a torque tool device which can be provided with traceability from the torque tool to standards of torque.

A torque wrench 1 transmits, after having tightened a bolt, a set of the manufacturer's serial number of the torque wrench 1 and tightening data such as a measured torque value to a processing terminal 20. The processing terminal 20 transmits the manufacturer's serial number and the tightening data to an externally connected device 30, so that the tightening data and data on the tightened bolt or the like are recorded by the manufacturer's serial number in the externally connected device. This makes it possible to identify the torque wrench 1 from the tightened bolt and maintain traceability.

### TECHNICAL FIELD

The present invention relates to torque tool devices which transmit tightening data such as the measured torque value of clamp members such as bolts to a processing terminal by radio in conjunction with the manufacturer's serial number of a torque tool such as a torque wrench, thereby allowing the tightening data and data identifying a clamp member such as a bolt tightened to be managed by the manufacturer's serial number of the torque tool. This can provide traceability from the torque tool to torque standards.

### BACKGROUND ART

A torque wrench has been conventionally used to tighten consecutively a number of clamp members such as bolts. In this case, there could be some bolts that were not tightened at a correct torque value or not tightened at all by mistake.

To overcome such problems, it is necessary to collect data (hereinafter referred to as tightening data) such as the measured torque value of a bolt provided when being tightened, the number of bolts tightened, and a tightening completion signal transmitted when having tightened a bolt to check the number of tightened bolts, and to manage the bolt tightening data.

As a related prior art, there is a data transfer device disclosed in Patent Document 1. Patent Document 1 describes an invention that relates to the data transfer device having a torque wrench, an interface, and a personal computer. The torque wrench includes a processing circuit which can accumulate data such as the measured torque value of a bolt provided when being tightened and the number of bolts tightened, and a transmitter which can transmit these pieces of data by radio. The interface can receive the data transmitted from the torque wrench and indicate the received data. Finally, the personal computer is connected to the interface to record the received data for processing and management of the data.

According to this invention, since the tightening data such as measured torque values can be collected and managed, it is possible to check from the measured torque values recorded to see if the tightening has been adequately performed. It is also possible to confirm from the recorded number of tightened bolts if any of them has not been tightened by mistake.
[Patent Document 1] Japanese Patent Application Laid-Open No. Hei. 8-118251

### DISCLOSURE OF THE INVENTION

### Problems to be Solved by the Invention

According to the data transfer device mentioned above, it is possible to manage data such as measured torque values and the number of bolts tightened. However, a large number of torque wrenches may be used in factory assembly lines to tighten multiple bolts consecutively. In this case, for ease of data management, the tightening data for each torque wrench needs to be put together at one place or consolidated into several management personal computers. Additionally, to record the tightening data of a plurality of torque wrenches at one place, it is necessary to identify which torque wrench provided each piece of the tightening data.

For example, when an inspection of tightened bolts shows that some bolts were not tightened at an adequate torque value, it is necessary to check, from the data recorded in the management personal computer, which torque wrench was used for its tightening, and then inspect the torque wrench in question.

However, if the tightening data has not been distinguished by the torque wrench, the torque wrench cannot be identified.

On the other hand, if the torque wrench is given an arbitrary identification number such as an in-house serial number and the tightening data is recorded in conjunction with the identification number, then the torque wrench can be identified from the data. However, even in this case, for example, the presence of torque wrenches having the same identification number or having an altered identification number different from its original one would make it difficult to identify which torque wrench provided the tightening data.

Furthermore, the tightening may not be adequately performed as described above conceivably because of the following reasons. That is, the operator who manipulates the torque wrench may not do so properly. Probably, the torque wrench itself may have some failure or malfunction, or the torque wrench tester for calibrating the torque wrench may have some problems. If the torque wrench has a malfunction, the torque wrench needs to be identified and inspected with a torque wrench tester or the like, thereby being checked to eliminate the malfunction. On the other hand, if there is any problem with the calibrator or the torque wrench tester, then it is necessary to identify which torque wrench tester was used to calibrate the torque wrench.

Currently, the traceability system has been suggested as shown in FIG. 6 to ensure the accuracy or uncertainty of torque realized by a torque tool such as a torque wrench, thereby assuring its reliability. This torque traceability system has at its top the National Standard Institute that provides standards for all the torque devices in Japan. The system has the flow on the left of FIG. 6 which includes a length reference device and a reference torque wrench (Test lever) which have been calibrated by the National Standard Institute and are positioned in a lower layer to ensure the accuracy of length. The system also has a weight as a mass reference device and the flow on the right of FIG. 6 which includes a weight and a balance whose accuracy is ensured by the weight to ensure the accuracy of mass. The system further has a torque wrench tester calibrated by both the length and mass standard devices, and an end-use torque tool such as a torque wrench which is inspected and calibrated by this torque wrench tester.

This system makes it possible to trace, up to the level of the National Standard Institute, which torque wrench calibration device such as a torque wrench tester was used to inspect an end-use torque wrench as well as which reference device or reference torque wrench was used to calibrate the torque wrench tester. This assures a certain level of accuracy of the torque realized by the tightening with a torque wrench so long as the torque wrench is inspected and calibrated within this traceability system.

However, as described above, unless which torque wrench provided the recorded tightening data is positively identified, it would not be possible to perform the inspection of the torque wrench that should be carried out at the time of an inspection using a torque wrench tester in a one-level higher layer. Also which torque wrench tester was used to calibrate the torque wrench may not be identified. For these reasons, traceability cannot be ensured. It will be thus impossible to maintain effectively the traceability system suggested.

It is therefore an object of the present invention to provide a torque tool device having a torque tool such as a torque wrench, which allows the construction of a traceability system from an end-use torque wrench to national standards of torque. This maybe realized by transmitting information, the information being capable of positively identifying which torque wrench provided the tightening data when having been used for the tightening, to an information management terminal in conjunction with tightening data, and then by recording the information in the information management terminal.

### Means for Solving the Problems

The present invention provides a torque tool device which is made up of a torque tool having first wireless communication means for transmitting, upon completion of tightening a bolt, information containing at least a manufacturer's serial number of the torque tool and a signal indicative of the completion of the tightening; and an information processing terminal having second wireless communication means which is capable of transmitting and receiving information to/from the first wireless communication means. The torque tool device is characterized in that upon reception of the information containing the manufacturer's serial number and the signal indicative of the completion of the tightening transmitted by the first wireless communication means via the second wireless communication means, the information processing terminal transfers the information to an externally connected information management device which is connected to the information processing terminal.

### Effects of the Invention

The torque tool device according to the present invention is configured such that the manufacturer's serial number unique to each torque wrench is transmitted from the torque wrench to the information processing terminal, allowing the tightening data such as a signal indicative of the completion of tightening to be recorded corresponding to the manufacturer's serial number in an information management personal computer. It is thus possible to identify positively which torque wrench provided the data indicative of the completion of tightening. Furthermore, by enabling it to identify which torque wrench was used to tighten a clamp member such as a bolt in question, it is possible to construct a traceability system from the tightened clamp member to the National Standard Institute of torque.

### BRIEF DESCRIPTION OF THE DRAWINGS

FIG. 1 is a schematic view illustrating a torque tool device of an embodiment.

FIG. 2 is a circuit diagram illustrating the configuration of a torque tool shown in FIG. 1.

FIG. 3 is a circuit diagram illustrating the configuration of a processing terminal shown in FIG. 1.

FIG. 4 is a timing chart illustrating the operation of the torque tool device shown in FIG. 1.

FIG. 5 is a flowchart illustrating a management method for the torque tool device shown in FIG. 1.

FIG. 6 is a traceability system diagram which can be implemented by the torque wrench according to the present embodiment.

### DESCRIPTION OF THE REFERENCE NUMERALS

1 Torque wrench
2 Case
3 Torque wrench body
4 Liquid crystal display unit
5 Antenna
6 LED
8 Radio module
9 CPU
10 Identification number memory
20 Information processing terminal
22 Antenna
24 Radio module
25 CPU
26 Memory
30 Externally connected device

### BEST MODE FOR CARRYING OUT THE INVENTION

With reference to the drawings, a description will now be made to an embodiment of a torque tool device which provides traceability according to the present invention.

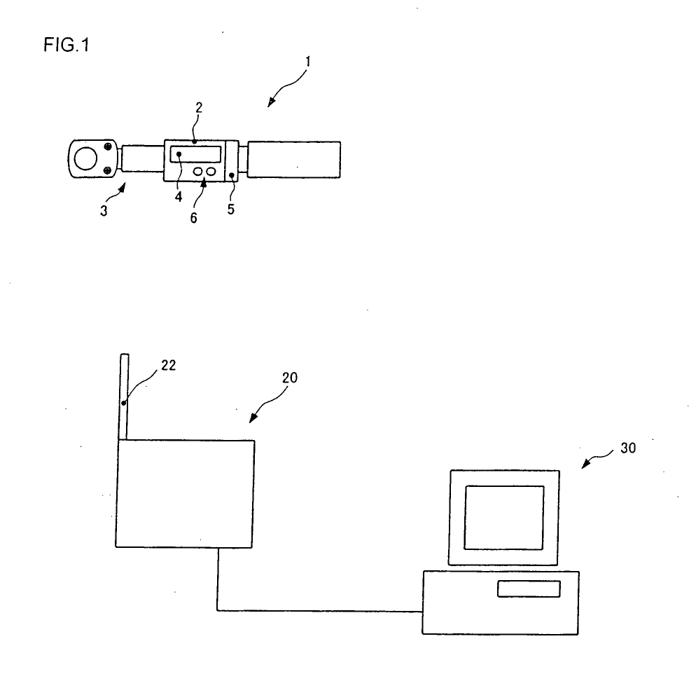

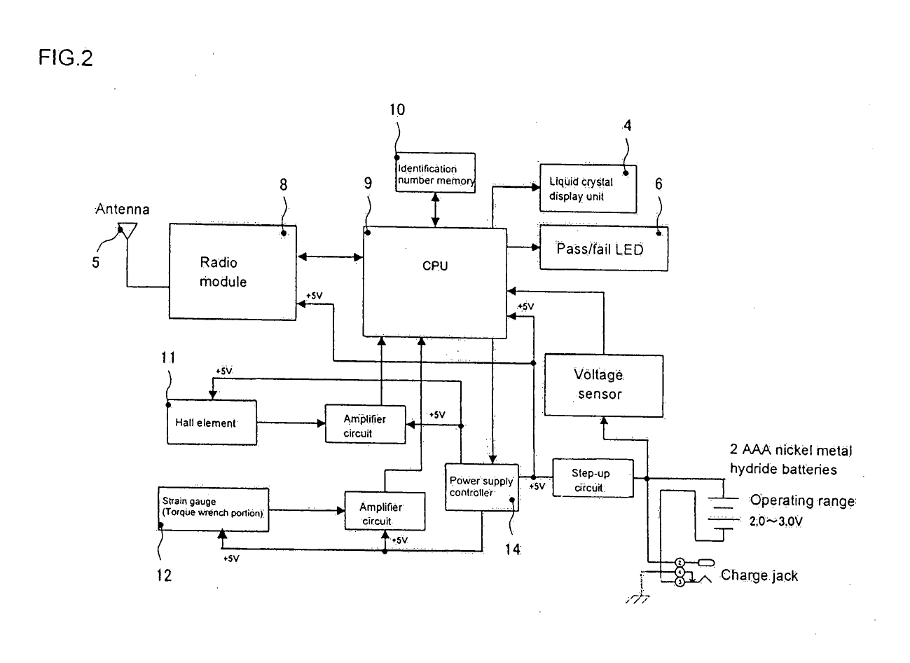

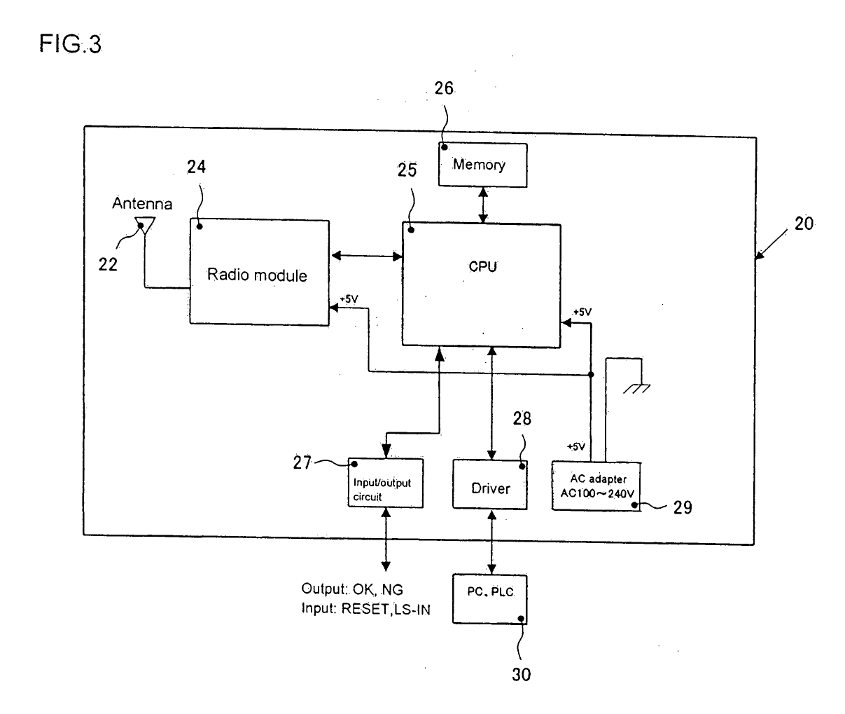

FIG. 1 is a schematic view illustrating a traceable torque tool device according to the embodiment of the present invention. The torque tool device of the present embodiment is made up of a torque wrench 1 and a tightening operation information processing terminal (hereinafter referred to as the processing terminal) 20. The torque wrench 1 is a torque tool for tightening clamp members such as bolts and nuts (hereinafter bolts will be described as an example). The processing terminal 20 wirelessly transmits and receives information such as a signal indicative of the completion of tightening of a bolt to/from the torque wrench 1. FIG. 2 is a circuit diagram of a torque wrench circuit section which the torque wrench 1 has, and FIG. 3 is a circuit diagram of the processing terminal 20.

The torque tool device of the present embodiment is configured such that when the torque wrench 1 has tightened a bolt, a signal indicative of the completion of the tightening and a signal containing the manufacturer's serial number unique to the torque wrench 1 are transmitted to the processing terminal 20. Then torque tool device allows the bolt-tightening completion signal to be recorded in conjunction with the manufacturer's serial number unique to the torque wrench. The tightening-completion signal outputted from the processing terminal 20 to a computer or the like can be thus recorded in conjunction with the manufacturer's serial number or a number unique to the torque wrench 1. This makes it possible to identify positively based on the recorded tightening-completion signal which torque wrench 1 was used for the tightening. This allows for identifying the torque wrench 1 from the data of the tightened bolt and ensures traceability from the torque wrench 1 to the national torque standards.

Furthermore, since the signal communicated wirelessly between the torque wrench 1 and the processing terminal 20 contains the manufacturer's serial number unique to the torque wrench, the manufacturer's serial number serves also as the identification number of the radio waves transmitted between the torque wrench and the processing terminal, thereby preventing communication interference.

Here, the tightening-completion signal transmitted by the torque wrench 1 in conjunction with the manufacturer's serial number can be any signal so long as it is indicative of the tightening of a bolt by the torque wrench 1. For example, those signals may include one that is outputted when it is sensed that the torque wrench 1 having started tightening released the tightening. Alternatively, for a torque wrench which electrically measures the bolt tightening torque and then transmits the measured torque value to the processing terminal for record purpose, the signal indicative of the measured torque value may be adopted as the tightening-completion signal. In the present embodiment, such a case will be described where a strain gauge 12 attached to the torque wrench 1 is used to measure a bolt tightening torque and then transmits the maximum torque value obtained until the tightening is released (hereinafter referred to as the measured torque value) as the tightening-completion signal to the processing terminal 20.

A description will now be made to the configuration of a torque wrench circuit section of the torque wrench 1 shown in FIG. 2. The torque wrench circuit section has a CPU 9 for controlling the entire circuit, and first wireless communication means including an antenna 5 and a radio module 8 (and the CPU 9). Furthermore, the torque wrench circuit section has an identification number memory 10 for storing the manufacturer's serial number that is transmitted and received as the identification number of the tightening-completion signal.

Furthermore, the torque wrench 1 of the present embodiment includes torque measurement means which is made up of the strain gauge 12 and the CPU 9; a liquid crystal display unit 4 for displaying measured torque values; and a pass/fail LED 6 for being turned on to indicate whether a measured torque value falls within the range of pre-set specified torque values.

With the torque measurement means, the strain gauge 12 senses, as a change in voltage, the strain produced in the torque wrench 1 while the bolt is being tightened. The change in voltage is then converted by the CPU 9 to a torque value, thereby measuring the torque.

As described above, the pass/fail LED 6 makes a pass/fail determination of whether the measured torque value transmitted to the processing terminal 20, to be discussed later, lies within the range of pre-set torque values (hereinafter referred to as the specified torque values) which the processing terminal 20 uses as the pass criteria for the test. When the result is transmitted to the torque wrench 1 for processing, the pass/fail LED 6 serves as the means for being turned on to indicate the result. That is, when the torque wrench 1 has received a pass/fail test result from the processing terminal 20, the pass/fail LED 6 is turned on depending on the pass/fail test result. For example, with the pass/fail LED 6 made up of a green LED and a red LED, the operator visually checks the pass/fail test result of the tightening operation in such a manner that the green LED being turned on indicates “Pass”, whereas the red LED being turned on indicates “Fail.”

Note that the CPU 9 allows a voltage sensor to sense the voltage of a power supply battery (with an operative range of 2.0 to 3.0 V). The CPU 9 also allows a step-up circuit to multiply the voltage of the power supply battery (to 5 V) for supply to the CPU 9 and the radio module 8, and allows the voltage controlled by a power supply controller to be supplied to each amplifier circuit and the strain gauge 12. Note that the signal detected at the strain gauge 12 is amplified at the amplifier circuit for supply to the CPU 9. Furthermore, the power supply battery can be charged by connecting its charge jack to a power supply.

A description will now be made to the configuration of the processing terminal 20 shown in FIG. 3. The processing terminal 20 includes second wireless communication means, which is made up of an antenna 22 and a radio module 24 (and a CPU 25), for receiving signals concerning the tightening of bolts from the torque wrench 1. The processing terminal 20 further includes the CPU 25 which controls each component device and conducts the pass/fail test of received torque values, and a memory 26 for storing the manufacturer's serial number of the torque wrench 1 and (the range of) the specified torque values that are used as the pass criteria.

When the CPU 25 receives the tightening-completion signal containing the measured torque value and the manufacturer's serial number from the torque wrench 1 via the second wireless communication means, the CPU 25 determines whether the received manufacturer's serial number matches with a manufacturer's serial number stored in the memory 26. If they match with each other, the received information is transmitted to an externally connected device 30 connected to record measured torque values or the like, or if required, the received measured torque value is determined whether it has passed the pass/fail test. On the other hand, if there is no match between the manufacturer's serial numbers, then no processing is performed on the received signal.

The processing terminal 20 is connected to the externally connected device 30 such as a computer via a driver 28, and capable of outputting the received information such as the measured torque value and the manufacturer's serial number received from the torque wrench 1 to the externally connected device 30. Furthermore, the processing terminal 20 employs, as its power supply, an AC adaptor 29.

With the torque tool device according to the present embodiment described above, the torque wrench 1 may be used to tighten a clamp member such as a bolt or nut. In this case, the manufacturer's serial number of the torque wrench 1 read from the identification number memory 10 and the measured torque value provided by the torque measurement means (such as the strain gauge 12 and the CPU 9) are transmitted to the processing terminal 20 via the wireless communication means of the torque wrench 1 (such as the antenna 5 and the radio module 8). At this time, for example, 2.4 GHz frequency band radio waves may be used. The processing terminal 20 receives the measured torque value and the manufacturer's serial number via the wireless communication means (the antenna 22 and the radio module 24). Then, if the manufacturer's serial number and a manufacturer's serial number recorded in the memory 26 match with each other, the processing terminal 20 forwards the measured torque value to the externally connected information management device 30 which has a personal computer (PC) or a programmable controller (PLC). The externally connected device 30 records the manufacturer's serial number and the measured torque value corresponding to the information on the tightened clamp member such as a bolt (for example, the information on the number that identifies the bolt or on the position of the bolt being tightened, hereinafter referred to as the bolt information). This facilitates data management even when the information on multiple torque wrenches is maintained in one externally connected device 30, because the measured torque value and the associated bolt information can be recorded by each manufacturer's serial number of the torque wrenches. It is thus possible to identify the torque wrench 1 based on the bolt tightened.

Furthermore, to perform the aforementioned pass/fail test on the measured torque value received by the processing terminal 20, the CPU 25 reads the specified torque values from the memory 26 to determine whether the measured torque value lies within the range of the specified torque values. Here, the specified torque values show the range of torque values required to tighten the bolts in question. If the CPU 25 determines that the measured torque value lies within the range of the specified torque values, then the measured torque value is determined to have passed the test. As such, to perform the pass/fail test at the processing terminal 20, the pass/fail test result is outputted to the externally connected device 30 in conjunction with the measured torque value and the manufacturer's serial number for record purpose. Furthermore, the pass/fail test result is transmitted to the torque wrench 1 via the wireless communication means, so that on the part of the torque wrench 1, the received pass/fail test result is reported to the operator by turning on either one of the pass/fail LEDs 6 provided on a case 2. This allows the operator to decide at the end of the tightening operation whether the tightening was correctly performed in accordance with the specified torque value. Note that to perform the pass/fail test and turn on the pass/fail LED 6 of the torque wrench 1, the processing terminal 20 transmits the pass/fail test result to the torque wrench 1. In this case, the manufacturer's serial number of the torque wrench 1 is also transmitted in conjunction with the pass/fail test result. The CPU 9 of the torque wrench 1 reads the manufacturer's serial number of itself from the identification number memory 10 to determine whether the received manufacturer's serial number matches it. If the manufacturer's serial numbers match with each other, the pass/fail LED 6 is turned on according to the pass/fail test result. But if there is no match, then the pass/fail LED 6 will not be lit.

Note that as described above, in the present embodiment, the measured torque value which has been obtained until tightening is released is transmitted as the tightening-completion signal. However, if torque is not measured when a bolt is tightened, all the data concerning the tightening to be recorded is only that indicative of the completion of the tightening of the bolt. That is, when a bolt is tightened without measuring the torque, the torque wrench 1 transmits only a signal indicative of the manufacturer's serial number and the tightening-completion to the processing terminal 20. Then, after the processing terminal 20 has received the signal, the externally connected device 30 records the manufacturer's serial number and the data indicative of the fact that the bolt was tightened (for example, the date and time of the tightening).

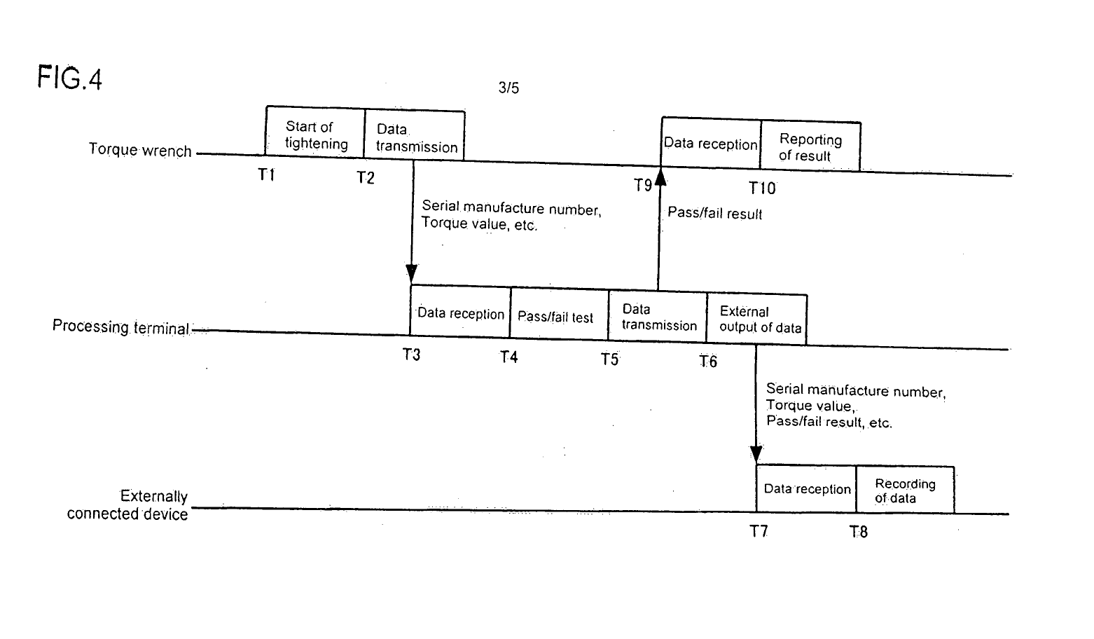

With reference to the timing chart shown in FIG. 4, a description will now be made to the flow of the communications of data between the torque wrench 1 and the processing terminal 20, the transmission of data from the processing terminal 20 to the external output device, and the recording of the data therein.

(Time T1) The bolt is tightened using the torque wrench 1, and the torque value at which the bolt is tightened is measured.

(Time T2) The measured torque value obtained at time T1 is transmitted to the processing terminal 20 in conjunction with the manufacturer's serial number of the torque wrench 1.

(Time T3 and time T4) Upon reception of the data, the processing terminal 20 makes a pass/fail determination of whether the measured torque value falls within the range of the pre-set specified torque values.

(Time T5) The pass/fail test result is transmitted to the torque wrench 1.

(Time T6) The manufacturer's serial number, the data concerning the tightening such as the measured torque value, and the pass/fail result are outputted to the externally connected device 30.

(Time T7) The externally connected device 30 receives the data transmitted at time T6, and (time T8) records the data. At this time, as described above, for example, the bolt the torque wrench 1 is going to tighten is pre-determined. The bolt information, the manufacturer's serial number, and data concerning the tightening are correlated with each other for recording so as to identify which bolt was tightened with the torque wrench 1.

(Time T9 and time T10) Based on the received pass/fail test result, the torque wrench 1 turns on the LED 6 that serves as the pass/fail test result report means of the torque wrench 1.

Note that although the pass/fail test is conducted at time T4 above, it can be eliminated if there is no need for the pass/fail test. In that case, the transmission of pass/fail result to the torque wrench 1 is not performed, while the pass/fail result is not reported in time T10, and the recording of the pass/fail result in the externally connected device 30 at time T8 is not performed. Furthermore, as described above, if the torque wrench 1 does not measure the torque during a tightening operation, instead of the measured torque value being transmitted to the processing terminal 20, a bolt-tightening completion signal is transmitted once the bolt is tightened completely. Then, the externally connected device 30 records only such data indicative of the fact that the tightening was carried out (such as date and time).

With the arrangement as described above, for example, suppose that for a series of assembly operations in a car factory production line, a torque wrench with a manufacturer's serial number ABCD is assigned to the tightening of a bolt No. 00X for fixing a seat of a car. In this case, the information on the assigned bolt (that the torque wrench with the manufacturer's serial number ABCD is used to tighten the bolt No. 00X) is registered with the externally connected device 30. When the manufacturer's serial number of the torque wrench with the manufacturer's serial number ABCD, and the tightening data such as the tightening-completion signal or the measured torque value are received from the processing terminal 20, the tightening data is recorded in association with the bolt information. This makes it possible to check even afterwards which torque wrench was used to tighten the bolt No. 00X. It is thus possible to ensure that the bolt No. 00X was tightened with the torque wrench having the manufacturer's serial number ABCD.

Furthermore, as described above, the torque wrench 1 of the present embodiment is configured such that the manufacturer's serial number unique to each torque wrench 1 is transmitted to the processing terminal 20 in conjunction with the measured torque value or the tightening-completion signal for record purpose in the externally connected device 30. A manufacturer's serial number is allotted to only one torque wrench and thus will never overlap the numbers of other torque wrenches, without any possibility of the number being altered or changed into a fictitious one. It is thus possible to identify one torque wrench 1 with certainty based on the manufacturer's serial number. In contrast to this, if an arbitrarily set number is given to each torque wrench, the correspondence between the number and the torque wrench is not always assured.

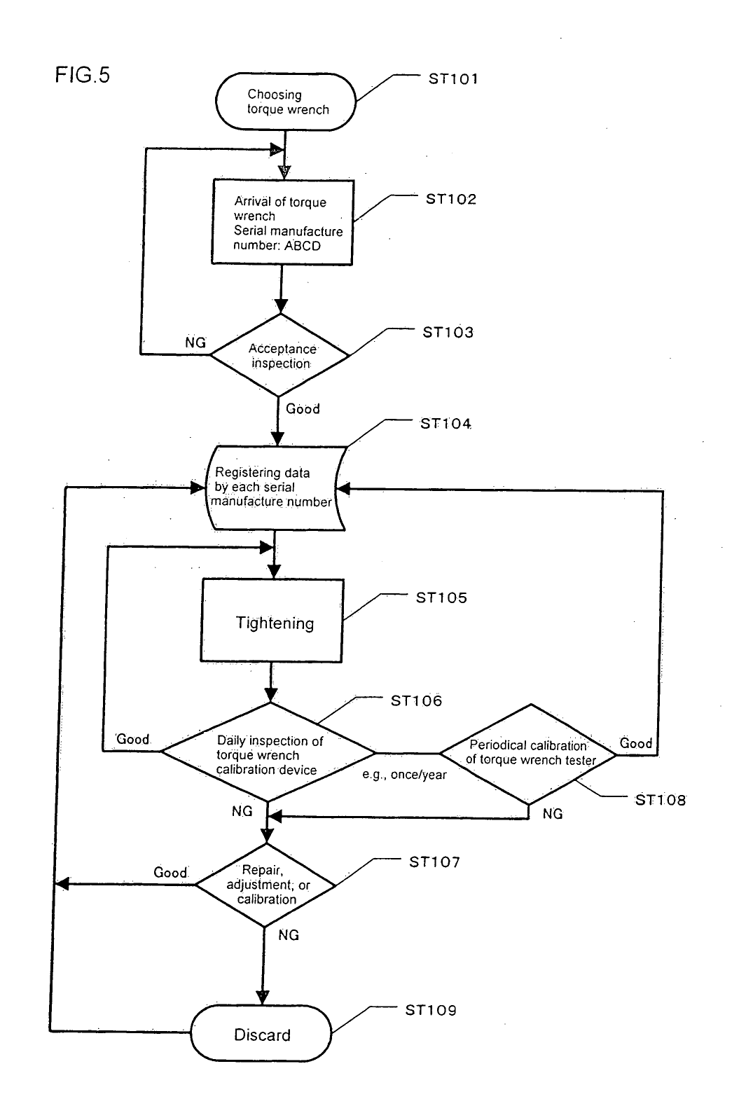

With reference to the flowchart shown in FIG. 5, a description will now be made to a management method for maintaining traceability of which tester or calibrator, placed in the upper layer of the traceability system, was used to test or calibrate the torque wrench 1 of the present embodiment.

First, a new torque wrench 1 is chosen and the torque wrench with the manufacturer's serial number ABCD selected is introduced into the factory or the like (ST101 and ST102).

Then, an acceptance inspection in ST103 may provide the inspection result (Good) that the torque wrench with the manufacturer's serial number ABCD properly operates and is acceptable. In this case, the manufacturer's serial number of the torque wrench 1 and the inspection result information on the aforementioned acceptance inspection are registered with the external output data management device 30. Alternatively, the number and result information are registered with the database of a tool management terminal for controlling tools such as the torque wrench 1 if the tool management terminal is available (ST104).

On the other hand, if such an inspection result was provided in ST103 that the introduced torque wrench 1 cannot be accepted because of its low quality or for some other reason, the torque wrench 1 is returned to its maker to be replaced with another normal torque wrench or alternatively the returned torque wrench 1 may be repaired and then its manufacturer's serial number is registered in ST104 in the same manner as stated above.

After its manufacturer's serial number has been completely registered in the external output data management device 30 or the tool management database, the torque wrench 1 is used for subsequent tightening operations. Then, upon performing a tightening operation, following the process flow shown in FIG. 4, the measured torque value or the tightening-completion signal are recorded in the external output data management device 30 by each manufacturer's serial number registered (ST105). After the tightening operation, as daily inspections, a simple torque wrench inspection device that is placed in a layer higher by one level than that of the torque wrench 1 in the traceability system is used to check whether the torque wrench 1 can be used for tightening with a correct torque (ST106). If the daily inspections show that the torque wrench 1 performs tightening with the correct torque (Good), the torque wrench 1 is used again for tightening operations. On the other hand, if the inspection showed an improper measurement (NG), then the torque wrench 1 is repaired, adjusted, or calibrated (ST107).

If the torque wrench 1 is found to be capable of performing tightening with a correct torque as the result of the repair or adjustment (Good), then the manufacturer's serial number of the torque wrench 1 as well as the information on the torque checker used when it was determined NG and the information on the repair or adjustment are recorded either in the external output device 30 or the tool management database (ST104). On the other hand, if the torque wrench 1 cannot perform proper tightening operations even after the repair or adjustment (NG), the torque wrench 1 is discarded (ST109), while the fact that it was discarded is registered with the data associated with the manufacturer's serial number of the torque wrench 1 (ST104).

Furthermore, instead of the daily inspection in ST106, for example, at annual intervals, a torque wrench tester serving as a torque wrench calibration device may be used for periodical calibrations of the torque wrench 1 (ST108). The torque wrench tester can measure the accuracy of the torque wrench more correctly than the torque wrench inspection device used for the daily inspection, and calibrate the torque wrench as required. The calibration result provided by the torque wrench tester is processed in the same manner as the aforementioned daily inspection result. Then, the information on which torque wrench tester was used for calibration and the information on the calibration result is registered in association with the data corresponding to each manufacturer's serial number.

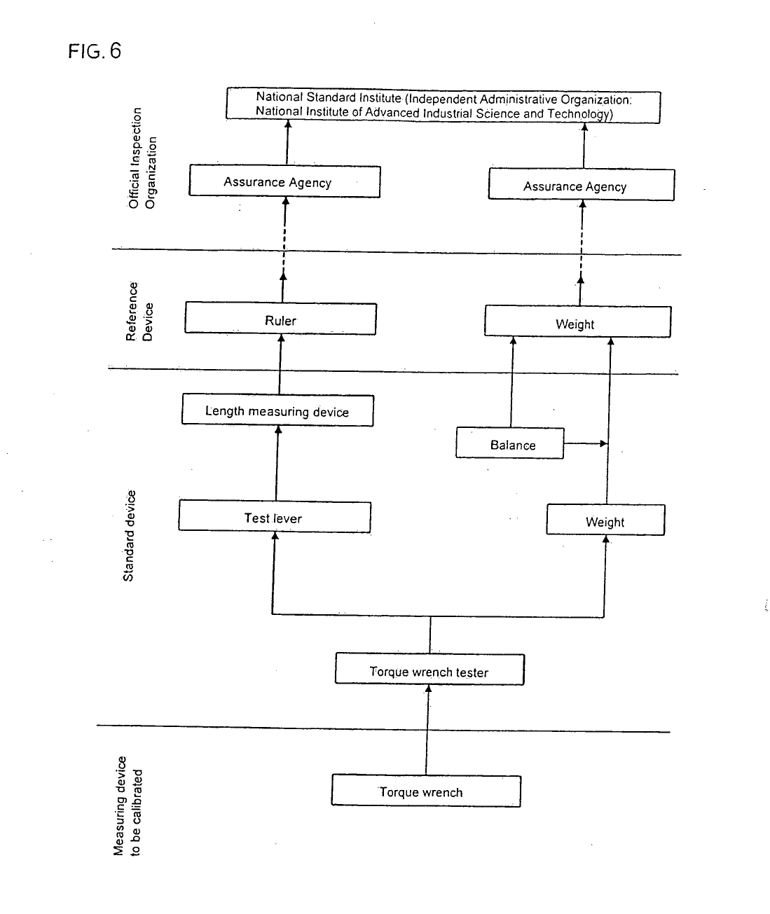

This makes it possible to identify which torque wrench inspection device or torque wrench tester was used to inspect or calibrate the torque wrench 1 identified by the manufacturer's serial number. This also ensures that the torque wrench 1 has been adjusted or calibrated using a device whose accuracy is guaranteed by the traceability system with the National Standards Institute at its top, which provides standards for all the torque devices shown in FIG. 6. Thus, according to the torque wrench 1 of the present embodiment, it is always possible to verify that the bolt tightened using the torque wrench is tightened with a proper torque wrench that has been calibrated in accordance with the traceability system.

Furthermore, as described above, to transmit and receive the data on tightening such as the measured torque value or information such as the manufacturer's serial number, the torque wrench 1 and the processing terminal 20 of the present embodiment can use, for example, one of the ISM band or 2.4 GHz band frequencies that can be commonly used in the countries all over the world. It is thus possible to provide high-speed communications between the torque wrench 1 and the processing terminal 20. Accordingly, the time required for communications will not be increased even when an increased amount of information is transmitted from the torque wrench 1 to the processing terminal 20 in order to transmit identification information such as the manufacturer's serial number in addition to the measured torque value. In particular, even when the processing terminal 20 conducts the pass/fail test and then reports the result at the torque wrench 1, it will not take a long time to report the pass/fail result because the information is transmitted and received using the 2.4 GHz band frequencies. For this reason, the operator can obtain the pass/fail result immediately. On the other hand, the present invention is not limited to the radio wave frequencies used for transmitting and receiving information between the torque wrench 1 and the processing terminal 20 according to the present embodiment. It is also possible to employ any frequency band so long as it can realize such a communication speed as will not prevent quick tightening operations.

As described above, according to the torque tool device of the present embodiment, the torque wrench 1 transmits the manufacturer's serial number unique to itself to the processing terminal 20. This makes it possible to allow the externally connected information management device 30 to record the tightening data such as the measured torque value corresponding to the manufacturer's serial number. It is thus possible to identify positively which torque wrench provided the tightening data.

Furthermore, the torque tool device of the present embodiment allows for identifying which torque wrench was used to tighten the bolt in question. It is thus possible to build a traceability system from the bolt tightened to the National Standard Institute that provides standards for all torque devices. Accordingly, when there is a problem with the tightening of bolts, the torque wrench used to tighten the bolt can be surely identified from the data recorded corresponding to the bolt and the manufacturer's serial number of the torque wrench.

1. A torque tool device comprising:
a torque tool having first wireless communication means for transmitting, upon completion of tightening a bolt, information containing at least a manufacturer's serial number of the torque tool and a signal indicative of a completion of the tightening; and
an information processing terminal having second wireless communication means which is capable of transmitting and receiving information to/from the first wireless communication means, wherein
upon reception of the information containing the manufacturer's serial number and the signal indicative of the completion of the tightening transmitted by the first wireless communication means via the second wireless communication means, the information processing terminal transfers the information to an externally connected information management device which is connected to the information processing terminal.

2. The torque tool device according to claim 1, wherein a bolt tightened with the torque tool is identified, whereby the information is recorded corresponding to bolt-identifying information in the externally connected information management device.

3. The torque tool device according to claim 1, wherein
the torque tool has torque measurement means for measuring a torque value at which a bolt is tightened, and
the first wireless communication means transmits a measured torque value as a signal indicative of the completion of the tightening.
